(19) United States
(12) Patent Application Publication
(10) Pub. No.: US 2007/0231611 A1
(43) Pub. Date: Oct. 4, 2007

(54) Magnetic recording medium and process of producing the same

(75) Inventor: Kouichi Masaki, Odawara-shi (JP)

Correspondence Address: SUGHRUE-265550, 2100 PENNSYLVANIA AVE. NW, WASHINGTON, DC, 20037-3213, US

(73) Assignee: FUJIFILM Corporation, Tokyo (JP)

(21) Appl. No.: 11/727,805

(22) Filed: Mar. 28, 2007

(30) Foreign Application Priority Data
Mar. 29, 2006 (JP) 2006-091897

(51) Int. Cl. G11B 5/716

(52) U.S. Cl. 428/840.2

(57) ABSTRACT

A magnetic recording medium including a substrate, a nonmagnetic layer containing nonmagnetic powder and a binder, and a magnetic layer containing ferromagnetic powder and a binder, in this order, wherein the nonmagnetic layer has a thickness of from 0.5 to 2.5 μm, a specific surface area of from 20 to 120 m²/ml, a pore volume of from 0.15 to 0.40 ml/ml, and a median pore radius of from 3 to 16 nm, and the nonmagnetic layer has particles having an average particle diameter of from 4 to 14 nm on a magnetic layer side.

### FIELD OF THE INVENTION

This invention relates to a magnetic recording medium and a process of producing the same.

### BACKGROUND OF THE INVENTION

Magnetic recording technology has been widely used in various applications, including video and computer data recording, because of its superior advantages over other recording systems, such as repeated usability of recording media, ease of signal digitalization, capability of system construction with peripheral equipment, and ease of signal correction.

To cope with the trends to smaller equipment, higher quality of reproduced signals, longer recording time, and increased recording capacity, there has always been a demand for recording media to have further improved recording density, reliability and durability.

For example, practical application of digital recording technology promising improved sound and image qualities and development of recording technology applicable to high-definition broadcast have boosted the demand for a magnetic recording medium that is writable and readable at shorter wavelengths than in conventional systems and exhibits high reliability and durability even at an increased relative running speed with respect to a head. Also in computer applications, a high-capacity digital recording medium has been awaited so as to store an ever increasing amount of data to be archived. In magnetic disk applications, too, the recent rapid increase of volume of data to be dealt with has raised the demand for a high-capacity floppy disk. In the field of high-capacity floppy disks containing ferromagnetic metal powder excellent in high-density recording characteristics, 100 MB or larger HDFDs (high-density floppy disks) are now available, but a system enabling still larger capacity and higher transfer rates is needed.

For the purpose of increasing the recording density on a magnetic recording medium, the wavelength of signals to be used has been getting shorter, and the track width of a reading head has been getting narrower. As the recording wavelength approaches a comparable size to the magnetic particle size, a clear transition state cannot be created, resulting in a substantial failure of recording. Therefore, it is required to develop magnetic particles sufficiently small in relation to the shortest wavelength used for high-density recording. From this aspect, the size of magnetic particles has continued to become smaller and smaller in response to market demands for higher recording capacity.

Magnetic tapes used in a digital signal recording system usually has a 2.0 to 3.0 μm thick single-layered magnetic coating containing ferromagnetic powder, a binder, and an abrasive on one side of a nonmagnetic substrate and a backcoating on the other side for preventing winding errors and maintaining running durability. Such a relatively thick single magnetic layer suffers from self demagnetization loss in writing and output reduction due to thickness loss in reading.

To reduce the magnetic layer thickness is known effective to minimize read output reduction due to the thickness loss. For example, JP-A-5-182178 discloses a magnetic recording medium comprising a nonmagnetic substrate having formed thereon a lower nonmagnetic layer containing inorganic powder dispersed in a binder and an upper magnetic layer containing ferromagnetic powder dispersed in a binder. The upper magnetic layer is applied to a dry thickness of 1.0 μm or smaller while the lower nonmagnetic layer is wet.

A magnetic recording medium should have an increased S/N in order to achieve size reduction of equipment, to improve reproduced signal quality, to increase recording time, and to increase recording capacity. A magnetic recording medium having, on its nonmagnetic substrate, at least two layers including a lower nonmagnetic layer containing nonmagnetic powder and a binder and an upper magnetic layer containing ferromagnetic powder and a binder shows, in principle, reduced self demagnetization and has a reduced surface roughness (reduced spacing loss) and therefore exhibits high performance. Nevertheless, it has turned out that the uniformity of the nonmagnetic layer/magnetic layer interface is of importance for obtaining an improved areal recording density. JP-A-5-73883 proposes a magnetic recording medium of which the magnetic layer has a thickness d of 1 μm or smaller and an average thickness variation Δd of d/2 or smaller. JP-A-5-298654 discloses a magnetic recording medium of which the magnetic layer has a thickness d of 0.01 to 0.3 μm and a standard deviation σ of thickness satisfying the relationship: 0.05≦σ/d≦0.5. However, because there is an effective recording depth which is estimated to be a quarter of the recording wavelength in short-wavelength recording, when the thickness of a magnetic layer is reduced to increase the recording density, the disturbances of the nonmagnetic layer/magnetic layer interface can cause noise.

A magnetoresistive head (MR head) with high sensitivity has recently been extending its use in computer data recording systems, which has pushed development of a recording system securing a high S/N. In this system, a system noise is governed by the noise caused by a magnetic recording medium. That is, it is essentially required for a recording medium applied to a system using an MR head to have a reduced noise. The recording medium is also required to have both running durability and a moderate head cleaning effect. In order to secure a high S/N and good running durability, proposals have been made with reference to the pore volume of a magnetic recording medium and migration of a lubricant as described in JP-A-2-260219, JP-A-2-260220, JP-A-2002-140808, JP-A-2002-208130, JP-A-2003-30813, JP-A-10-302245, JP-A-11-175949, and JP-A-2005-25905.

To address the problems, JP-A-2005-25905 proposes production of a magnetic recording medium with due considerations given to the particle size of ferromagnetic powder used in the magnetic layer, the abrasive, the filler for forming projections on the tape surface, the thickness of not only the magnetic layer but the nonmagnetic layer, and the surface characteristics including the internal structure. However, it is necessary to further reduce the interfacial variations between the nonmagnetic layer and the magnetic layer because the interfacial variations cause output fluctuations in the case of high density magnetic recording at a read track width of about 1 μm or smaller.

### SUMMARY OF THE INVENTION

An object of the present invention is to provide a magnetic recording medium that has reduced output fluctuations due to interfacial disturbances between the nonmagnetic and magnetic layers and achieves a high S/N and a low error rate even in high density recording at a read track width of about 1 μm or smaller; and a process of producing the magnetic recording medium.

The present inventors have found out that magnetic powder's being trapped in pores on the surface of the nonmagnetic layer causes the interfacial disturbances between the nonmagnetic layer and magnetic layer. They have extensively studied to solve this problem and reached the present invention.

The present invention provides, in a first aspect, a magnetic recording medium having a substrate, a nonmagnetic layer containing nonmagnetic powder and a binder, and a magnetic layer containing ferromagnetic powder and a binder in the order described. The nonmagnetic layer has a thickness of 0.5 to 2.5 μm, a specific surface area of 20 to 120 m²/ml, a pore volume of 0.15 to 0.40 ml/ml, and a median pore radius of 3 to 16 nm. The nonmagnetic layer has particles having an average particle diameter of 4 to 14 nm on its magnetic layer side.

The present invention provides preferred embodiments of the magnetic recording medium, in which

the nonmagnetic layer has its pores filled with particles having an average particle diameter of 4 to 14 nm,

the magnetic layer has a thickness of 25 to 150 nm,

the average particle diameter of the particles is not greater than the desorption pore radius D90 of the nonmagnetic layer,

the average particle diameter of the particles is not greater than the (desorption pore radius D10+desorption pore radius D90)/2 of the nonmagnetic layer, or

the magnetic recording medium is for use in reading recorded signals using a giant magnetoresistive (GMR) head with a read track width of 1 μm or smaller.

The present invention also provides, in its second aspect, a process of producing a magnetic recording medium having a substrate, a nonmagnetic layer containing nonmagnetic powder and a binder, and a magnetic layer containing ferromagnetic powder and a binder in the order described. The process includes the steps of applying a coating composition containing a nonmagnetic powder and a binder on a substrate to form a nonmagnetic layer having a thickness of 0.5 to 2.5 μm, a specific surface area of 20 to 120 m²/ml, a pore volume of 0.15 to 0.40 ml/ml, and a median pore radius of 3 to 16 nm, applying a dispersion containing particles having an average particle diameter of 4 to 14 nm on the nonmagnetic layer (so that the nonmagnetic layer has pores filled with particles), and applying thereon a coating composition containing ferromagnetic powder and a binder to form a magnetic layer.

In a preferred embodiment of the process, the dispersion contains 2% to 15% by weight of the particles which have an average diameter of not greater than the desorption pore radius D90 of the nonmagnetic layer.

According to the invention, the magnetic powder is prevented from being trapped in the pores on the surface of the nonmagnetic layer by specifying the ranges of the thickness, specific surface area, pore volume, and median pore radius of the nonmagnetic layer and providing fine particles having an average diameter of 4 to 14 nm on the magnetic layer side of the nonmagnetic layer, specifically by filling the pores of the nonmagnetic layer with the fine particles. The nonmagnetic layer/magnetic layer interfacial disturbances can thus be eliminated. As a result, there is obtained a magnetic recording medium achieving a high S/N and a low error rate even in high density recording at a read track width of about 1 μm or smaller.

According to the process of the invention, formation of a nonmagnetic layer on a substrate is followed by filling the pores of the nonmagnetic layer with fine particles, and a magnetic layer is then formed by a wet-on-dry coating technique. Therefore, the magnetic powder is prevented from being trapped in the pores on the surface of the nonmagnetic layer, and the nonmagnetic layer/magnetic layer interfacial disturbances can be eliminated. As a result, there is obtained a magnetic recording medium achieving a high S/N and a low error rate even in high density recording at a read track width of about 1 μm or smaller.

When ultrafine magnetic powder having high output, excellent dispersibility, and high durability is used in the thin magnetic layer, self demagnetization loss is reduced, and the output in the high frequency region is secured to decrease the noise in the full range. Overwrite performance is also improved. The effects of the thin magnetic layer are maximized in applications to a system using an MR head or a GMR head having a read track width of about 1 μm or less. That is, there is provided a high recording density magnetic recording medium exhibiting improved digital recording performance and superior running durability.

### DETAILED DESCRIPTION OF THE INVENTION

Noise of particulate magnetic recording media is caused by many factors, such as the size of magnetic particles, defects of the magnetic layer (e.g., surface roughness, voids, agglomeration of magnetic particles, disturbances in the interface with the lower layer, thickness variation, and distributions of various physical properties), and the degree of interaction between magnetic particles in the magnetic layer. The present inventors have investigated into the degrees of contribution of these factors to noise. They have ascertained as a result that the thickness, specific surface area, pore volume, and median pore radius of the nonmagnetic layer that is formed before formation of the magnetic layer exert great influences on the magnetic layer surface roughness, the magnetic powder agglomeration, the interfacial disturbances between the magnetic and the nonmagnetic layers, and the like. They have found accordingly that magnetic particles can be prevented from being trapped in the pores of the nonmagnetic layer by specifying these physical attributes of the nonmagnetic layer and, at the same time, filling the pores of the nonmagnetic layer with fine particles. As a result, the interfacial disturbances between the nonmagnetic layer and the magnetic layer can be eliminated, and a magnetic recording medium satisfying both high S/N and running durability can be produced.

The magnetic recording medium according to the present invention is preferably produced by a process including the steps of applying a coating composition containing a nonmagnetic powder and a binder on a substrate to form a nonmagnetic layer, applying a dispersion containing particles having an average particle diameter of 4 to 14 nm on the nonmagnetic layer, and applying thereon a coating composition containing ferromagnetic powder and a binder to form a magnetic layer.

To begin with, the characteristics of the nonmagnetic layer that are specified in the invention are described.

The thickness is 0.5 to 2.5 μm, preferably 0.5 to 2.0 μm, still preferably 0.6 to 2.0 μm.

With the nonmagnetic layer thickness falling within the range recited, the following effects are exerted. The nonmagnetic layer has adequate capability of holding a sufficient amount of a lubricant to secure running durability. An adequate pore volume is secured so that the solvent of a coating composition for a magnetic layer is prevented from selectively penetrating the nonmagnetic layer. Therefore, dissolution of the nonmagnetic layer is suppressed to reduce the surface roughness, which leads to reduction of surface roughness of the upper magnetic layer.

The specific surface area is 20 to 120 m²/ml, preferably 20 to 110 m²/ml, still preferably 20 to 100 m²/ml.

The pore volume is 0.15 to 0.40 ml/ml, preferably 0.16 to 0.39 ml/ml, still preferably 0.17 to 0.39 ml/ml.

The median pore radius is 3 to 16 nm, preferably 4 to 16 nm, still preferably 5 to 15 nm.

A coated web having the nonmagnetic layer satisfying the above-described conditions of specific surface area, pore volume and median pore radius shows good calenderability to reduce the surface roughness of the magnetic medium.

A nonmagnetic layer satisfying the conditions of specific surface area, pore volume, and median pore radius can be formed by, for example, (1) selecting the size and specific surface area of the powder used in the nonmagnetic layer, (2) controlling the amount of the binder used in the nonmagnetic layer, or (3) selecting the size, specific surface area, amount, and the like of conductive particles used in the nonmagnetic layer.

The specific surface area, pore volume, and median pore radius as referred to in the present invention are those measured by nitrogen adsorption. Measurements are made as follows. A nonmagnetic layer is formed on a substrate to prepare a sample, and a specimen with an area of 300 to 600 cm² is cut out. The specimen is measured for weight and thickness. After the specimen is degassed at room temperature for 5 hours, nitrogen adsorption/desorption isotherms are measured with an automatic gas adsorption analyzer AUTOSORB-1 from Quanta Chrome Inst. Co. at liquid-nitrogen temperature. The specific surface area per unit weight is calculated from the data according to multipoint BET method. The isotherms are analyzed by the BJH method to obtain the pore size distribution, from which the pore volume per unit weight and the median pore radius are calculated. The specific surface area per unit weight and the pore volume per unit weight are converted to those per unit volume (ml). The volume of the nonmagnetic layer is obtained from the area and thickness of the nonmagnetic layer.

Cumulative curves of pore distribution in nitrogen adsorption or desorption give adsorption or desorption D10 and D90 data. D10 and D90 are the pore radii at which the cumulative pore volume is 10% and 90%, respectively, of the total pore volume. The term “median pore radius” as used herein corresponds to D50 at which the cumulative pore volume is 50% of the total pore volume.

The particles filling the pores on the surface of the nonmagnetic layer are particles, either organic or inorganic, with an average diameter of 4 to 14 nm. To avoid confusion from the magnetic or nonmagnetic particles used in the magnetic or nonmagnetic layer, the particles filling the pores will hereinafter be called filler particles. The upper limit of the average diameter of usable filler particles is about the desorption pore radius D90 of the nonmagnetic layer. The lower limit is preferably about the desorption pore radius D10 of the nonmagnetic layer. Too fine particles smaller than the desorption pore radius D10 are difficult to disperse. Filler particles greater than the desorption pore radius D90, even if capable of filling the pores, produce insufficient effects on interfacial uniformity. In using platy, spherical or spheroidal magnetic particles, filler particles of from about the desorption pore radius D10 to about the desorption pore radius D90 in size can be used. In using acicular magnetic particles, it is preferred to use filler particles having an average particle diameter of the (desorption pore radius D10+desorption pore radius D90)/2 or smaller to prevent orientation disorder of the acicular magnetic particles. For example, filler particles having an average particle diameter of from about the desorption pore radius D10 to about the (desorption pore radius D10+desorption pore radius D90)/2 are preferred. It is also preferred for the filler particles to have a narrow particle size distribution. For example, the particle size distribution in terms of coefficient of variation (standard deviation/mean) is preferably 0% to 20%. The filler particles may be surface modified to have improved dispersibility. The dispersion of the filler particles used to fill the pores of the nonmagnetic layer surface is preferably controlled to have high flowability by using a low molecular weight binder or by adjusting the particle concentration to about 2% to 15% by weight. A low molecular weight binder polymerizable on irradiation with high energy rays is preferred. Such organic substances reactive on irradiation with high energy rays include UV curing resins and electron beam (EB) curing resins. Compounds having at least two EB sensitive double bonds per molecule, such as acrylic esters, acrylamides, methacrylic esters, methacrylamides, allyl compounds, vinyl ethers, and vinyl esters, are usually used as an EB curing resin. In particular, those having a weight average molecular weight of 50 to 4000 per double bond are preferred. Examples of such EB curing resins include monomeric (meth)acrylates such as bifunctional acrylates, e.g., 1,3-butanediol diacrylate, 1,4-butanediol diacrylate, 1,6-hexanedioldiacrylate, ethylene glycol diacrylate, diethylene glycol diacrylate, triethylene glycol diacrylate, tetraethylene glycol diacrylate, polyethylene glycol diacrylate, propylene glycol diacrylate, dipropylene glycol diacrylate, tripropylene glycol diacrylate, ethoxylated bisphenol A diacrylate, novolak diacrylate, and propoxylated neopentyl glycol diacrylate, and corresponding bifunctional methacrylates; trifunctional acrylates, e.g., tris(2-hydroxyethyl)isocyanurate triacrylate, trimethylolpropane triacrylate, ethoxylated trimethylolpropane triacrylate, pentaerythritol triacrylate, propoxylated trimethylolpropane triacrylate, propoxylated glycerol triacrylate, and caprolactone-modified trimethylolpropane triacrylate, and corresponding trifunctional methacrylates; and tetra- or higher functional acrylates, e.g., pentaerythritol tetraacrylate, ditrimethylolpropane tetraacrylate, ethoxylated pentaerythritol tetraacrylate, dipentaerythritol hydroxypentaacrylate, and dipentaerythritol hexaacrylate, and corresponding tetra- or higher functional methacrylates. Also included are compounds obtained by introducing EB sensitive double bonds into oligomers or polymers having an ether, ester, carbonate, epoxy, vinyl chloride or urethane skeleton by modification with these monomeric (meth)acrylates. These compounds can be used either alone or in combination thereof. Preferred of them are tetra- or higher functional acrylates. Pentaerythritol tetraacrylate, dipentaerythritol pentaacrylate, and dipentaerythritol hexaacrylate are particularly preferred. These aliphatic (meth)acrylates are known from literature, e.g., in UV-EB Koka Gijutu, Sogo Gijutu Center and Tei Energy Denshisen Shosha no Ohyo Gijutu, CMC Publishing (2000), or commercially available, e.g., from Nippon Kayaku Co., Ltd., Toagosei Co., Ltd., and Kyoeisha Chemical Co., Ltd.

Binders that can be used in the magnetic layer and nonmagnetic layer described later are also usable. The binder is used in an amount of 10% to 200% by weight, preferably 15% to 180% by weight, of the filler particles in the dispersion.

As stated, the average diameter of the filler particles is 4 to 14 nm, preferably 5 to 14 nm, still preferably 5 to 13 nm.

Examples of inorganic filler particles include oxide particles and nitride particles, preferably SiO₂, Al₂O₃, TiO₂, fullerene, and nanodiamond. Nonmagnetic powders described later for use in the nonmagnetic layer are also usable.

The dispersing medium for dispersing the filler particles include solvents such as alcohols and ketones, e.g., cyclohexanone and methyl ethyl ketone.

The thickness of the magnetic layer (upper layer) is preferably designed so as to have a predetermined Br·δ (Br: residual magnetic flux density; δ: magnetic layer thickness) in order to avoid saturation of a high sensitivity MR or GMR head. The magnetic layer preferably has a saturation magnetic flux density of 100 to 400 mT and a Br·δ of 0.5 to 40 mT·μm, still preferably 1.0 to 40 mT·μm. For reducing transition noise and enhancing resolution, the magnetic layer preferably has a thickness of 25 to 150 nm, still preferably 25 to 100 nm. Formation of such an ultrathin magnetic layer with a uniform thickness can be accomplished by uniformly applying a magnetic coating composition prepared by finely dispersing fine ferromagnetic particles and, if needed, fine nonmagnetic particles in a binder having high dispersing capability with the aid of a dispersant.

The magnetic layer preferably has a coercive force (Hc) of 125 kA/m or higher, still preferably 143 kA/m or higher, even still preferably 159 to 350 kA/m. While not explicit, it is considered that the upper limit of the coercive force will be raised with an improvement on a read head. The high recording density as aimed at in the present invention is attained when the magnetic layer has a coercive force of 125 kA/m or higher. It is desirable to optimize the coercive force, thickness, and Br·δ of the magnetic layer in accordance with the particular head used in the system to which the magnetic recording medium of the invention is applied.

The three dimensional average surface roughness (SRa; an arithmetic average of the height deviation from the mean plane) of the magnetic layer is preferably 2.7 nm or smaller, still preferably 2.5 nm or smaller, even still preferably 2.0 nm or smaller. The lower limit of SRa is not critical provided that the running durability is secured. It is usually about 0.5 nm. With the SRa being 2.7 nm or smaller, the head-to-medium spacing loss is minimized, and the magnetic recording medium is allowed to exhibit high output and low noise performance effectively.

Durability is a significant factor of a magnetic recording medium particularly where the running speed of a medium relative to a head should be increased to obtain a higher transfer rate. In magnetic tape applications, a helical scan system needs a head's rotational speed 1.5 to 10 or even more times higher than in conventional recording systems. Even in a linear recording system, it is necessary to increase the tape running speed. In magnetic disk applications, durability of a magnetic recording medium is an important subject because a magnetic head, components in a cartridge, and a recording medium slide at a high speed. Means for improving magnetic recording medium's durability include a binder formulation for increasing coating film strength and a lubricant formulation for assuring slip on a magnetic head.

In the present invention, it is preferred to adopt a what we call “3D network binder system” suited to an ultrathin magnetic layer to secure running stability and durability at high rotation speeds and high transfer rates.

As for the lubricant formulation, a plurality of lubricants exhibiting excellent effects under different ranges of environmental condition are used in combination so as to stably serve as a whole under a broad environmental range of from low to high temperatures and from low to high humidities.

The dual layer structure can also be taken advantage of to improve the running durability. The nonmagnetic layer acts as a lubricant reservoir that continuously supplies an adequate amount of a lubricant to the upper magnetic layer. In the case of a single layer structure, because the amount of a lubricant that can be incorporated into an ultrathin magnetic layer is limited, a reduction in magnetic layer thickness results in a reduction in absolute amount of the lubricant present in the layer, making it difficult to secure running durability. In the dual layer structure, the upper and lower layers are designed to perform their respective functions complemented by each other thereby to bring about improvements on both electromagnetic characteristics and durability. This sharing of function is particularly effective in a system where a magnetic head and a medium slide at a high relative speed.

The lower layer can serve for not only supplying a lubricant but also controlling surface resistivity. It is a generally followed practice to add a solid conductive material such as carbon black to a magnetic layer for electric resistance control. Addition of such a conductive material restricts of necessity the magnetic powder packing density and also adversely affects the surface roughness of such an ultrathin magnetic layer. Hence, incorporating a conductive material into the lower layer eliminates these disadvantages. Moreover, the lower layer produces a cushioning effect that improves the head touch and stabilizes the running properties.

The recording track density increases with increase in magnetic recording capacity and/or density. In general, a servo recording area is provided on a medium to ensure traceability of a magnetic head for a recording track.

The magnetic recording material of the invention is expected to have an improved linear recording density and an improved track density, which understandably brings about an increased recording density. The track traceability can further be improved by using a substrate with enhanced isotropic dimensional stability. The surface smoothness of the magnetic layer and the nonmagnetic layer/magnetic layer interface can further be improved by use of a substrate with an ultrasmooth surface. The magnetic layer and the backcoat layer of the magnetic recording medium of the invention have dimensional stability against temperature or humidity change.

The need for image recording has been intensified by the spread of multimedia systems for personal as well as industrial uses. The large capacity magnetic recording medium of the present invention is capable of fulfilling the demands for function and cost as a medium for storing not only text data but image data. The large capacity magnetic recording medium of the invention, being based on the time-proven particulate magnetic recording media, exhibits high reliability in long term use and boasts high cost performance.

The magnetic recording medium of the invention manifests its effects effectively in applications to magnetic recording systems based on elaboration of aforementioned various factors and synergistic and organic interaction among them.

The ferromagnetic powder that can be used in the invention includes ferromagnetic metal powder, hexagonal ferrite powder, ferromagnetic powder containing Fe₁₆N₂ as a main ingredient, and CuAu or Cu₃Au type ordered alloys, e.g., Fe—Pt. The ferromagnetic metal (inclusive of alloy) powder is not particularly limited as long as it contains α-Fe as a main ingredient. The ferromagnetic metal powder may contain other elements in addition to α-Fe, such as Al, Si, S, Ca, Mg, Ti, V, Cr, Cu, Y, Rh, Pd, Ag, Sn, Ba, Ta, W, Au, Bi, La, Ce, Pr, Nd, P, Co, Mn, Zn, Ni, Sr, and B. Those doped with at least one of Al, Si, Ca, Mg, Y, Ba, La, Nd, Co, Ni, and B, particularly at least one of Co, Al, Mg, Y, and Nd, are preferred. Still preferred are those containing 10 to 50 atom % of Co, 2 to 20 atom % of Al, 0 to 2 atom % of Mg, and 3 to 20 atom % of Y and/or Nd.

It is preferred for the ferromagnetic metal powder for use in the invention to assure high output and to have high dispersibility and improved orientation so as to maximize its performance in a high density region. Specifically, ultrafine ferromagnetic metal powder assuring high output, particularly one having an average length (major axis length) of 20 to 50 nm, a crystallite size of 8 to 14 nm, and a relatively high cobalt content, and containing an aluminum or yttrium compound as sintering inhibitor is preferably used to achieve high output and high durability. It is also important for the ferromagnetic metal powder to have a narrow size distribution, i.e., a coefficient of length variation (standard deviation/mean) of 0% to 25%. The ferromagnetic metal powder preferably has an average aspect ratio of 3.0 to 5.5, a coercive force of 143 to 223 kA/m, a saturation magnetization of 85 to 125 A·m²/kg, and a BET specific surface area (S_{BET}) of 45 to 120 m²/g. A ferromagnetic metal powder with these preferred characteristics is obtainable through the techniques or a combination of the techniques proposed in JP-A-9-22522, JP-A-9-106535, JP-A-6-340426, and JP-A-11-100213.

To accomplish high density recording, it is preferred for the ferromagnetic powder to have high coercivity. While varying according to the recording head used, a preferred coercive force ranges from 143 to 223 kA/m. An increase of coercivity poses an overwrite problem. Since the coercivity of ferromagnetic metal powder primarily depends on anisotropy in shape, it is preferred for the powder particles to have a small coefficient of shape variation.

The hexagonal ferrite magnetic powder that can be used in the magnetic layer is preferably a magnetoplumbite type hexaferrite, such as barium ferrite, strontium ferrite, lead ferrite, calcium ferrite, or a substitution derivative thereof. These ferrites may contain additional elements, such as Al, Si, S, Sc, Ti, V, Cr, Cu, Y, Mo, Rh, Pd, Ag, Sn, Pt, Ta, W, Re, Au, Pb, Bi, La, Ce, Pr, Nd, P, Co, Mn, Zn, Ni, Sr, B, Ge, and Nb. Usually, ferrites doped with Co—Ti, Co—Ti—Zr, Co—Nb, Co—Ti—Zn, Co—Zn—Nb, Ni—Ti—Zn, Nb—Zn, Ni—Ti, Zn—Ti, Zn—Ni, etc. can be used. From the standpoint of SFD (switching field distribution), pure magnetoplumbite type ferrites are preferred to composite ferrites containing extra spinel layers. The coercive force of the hexagonal ferrite powder can be controlled by composition, particle size (length and thickness), thickness of a spinel phase, amount of doping elements in the spinel phase, site of doping in the spinel phase, and the like.

The hexagonal ferrite magnetic powder preferably has an average length (diameter) of 10 to 35 nm and a coefficient of variation of length or thickness of 0% to 30%. The hexagonal ferrite powder usually has a thickness of 2 to 15 nm, preferably 4 to 10 nm. The aspect ratio is preferably 1.5 to 4.5, still preferably 2 to 4.2. The average length (average plate diameter (average tabular diameter)) falling within the above-recited preferred range, the specific surface area will be in a proper range, which assures dispersibility. A preferred specific surface area (S_{BET}) of the hexagonal ferrite magnetic powder is 40 to 100 m²/g, still preferably 45 to 90 m²/g. The powder with the preferred specific surface area is less causative of noise and easier to disperse, which is advantageous for obtaining good surface properties. A preferred water content is 0.3% to 2.0% by weight, and a pH is usually 5.0 to 12, preferably 5.5 to 10. It is advisable to optimize the water content and pH depending on the binder used in combination. The hexagonal ferrite magnetic powder preferably has a coercive force of 120 to 320 kA/m and a saturation magnetization of 40 to 55 A·m²/kg.

The ferromagnetic powder containing Fe₁₆N₂ as a main ingredient that can be used in the magnetic layer is described in JP-A-2006-41210, IEEE Trans. Magnetics, 42(3), 465-467 (2006). The CuAu or Cu₃Au type ordered alloys, e.g., Fe—Pt, that can be used in the magnetic layer are described in JP-A-2003-239006 and JP-A-2004-52042. These ferromagnetic powders preferably have an average particle size of 5 to 25 nm, an average aspect ratio of 1.0 to 1.5, a coercive force of 120 to 320 kA/m, a saturation magnetization of 40 to 100 A·m²/kg, and a specific surface area of 40 to 100 m²/g.

Prior to dispersing, the ferromagnetic powder may be subjected to pretreatment with a dispersant, a lubricant, a surface active agent, an antistatic agent, and so forth described infra.

The SFD of the ferromagnetic powder itself, a measure of the spread of individual particle coercivities, is preferably as small as possible. A magnetic tape having a small SFD shows a sharp magnetization reversal with a small-peak shift, which is advantageous for high-density digital magnetic recording. The coercivity distribution can be narrowed by, for example, using goethite with a narrow size distribution, using mono-dispersed α-Fe₂O₃ particles, or preventing sintering of particles. It also desirable that the composition be uniform among the individual particles.

The nonmagnetic powder that can be used in the nonmagnetic layer are selected from inorganic compounds, such as metal oxides, metal carbonates, metal nitrides, and metal carbides. Examples of the inorganic compounds include α-alumina, β-alumina, γ-alumina, θ-alumina, silicon carbide, chromium oxide, cerium oxide, ax-iron oxide, goethite, silicon nitride, titanium dioxide, silicon dioxide, tin oxide, magnesium oxide, zirconium oxide, zinc oxide, barium sulfate, and platy AlOOH. They can be used either individually or in combination. Preferred among them are titanium dioxide, zinc oxide, α-iron oxide, goethite, tin oxide, and barium sulfate, particularly titanium dioxide, α-iron oxide, and goethite, because they can be prepared with a small particle size distribution and be endowed with a desired function through many means. Alpha iron oxide is preferably prepared by thermally dehydrating a raw material for magnetic iron oxide or metal having a narrow size distribution, annealing the powder to reduce voids, and, if necessary, surface treating the powder with an aluminum or silicon compound.

Having photocatalytic activity, titanium dioxide can generate radicals on exposure to light and react with a binder or a lubricant. Therefore, it is recommended to reduce the photocatalytic activity of titanium oxide particles by dissolving 1% to 10% Al, Fe, etc. into the titanium oxide in the form of a solid solution or treating the titanium oxide particles with an aluminum or silicon compound.

The nonmagnetic powder which is needle-like powder preferably has an average length (major axis length) of 30 to 300 nm. If desired, nonmagnetic powders different in particle size may be used in combination, or a single kind of a nonmagnetic powder having a broadened size distribution may be used to produce the same effect. A still preferred average length of the nonmagnetic powder is 30 to 200 nm. The nonmagnetic powder which is not needle-like preferably has an average particle size of 30 nm or smaller.

The tap density of the nonmagnetic powder is usually 0.4 to 1.5 g/ml, preferably 0.5 to 1.3 g/ml. The water content of the nonmagnetic powder is usually 0.2% to 5% by weight, preferably 0.3% to 3% by weight, still preferably 0.3% to 1.5% by weight.

The nonmagnetic powder preferably has a pH of 4 to 12, still preferably 5.5 to 11. The specific surface area (S_{BET}) is usually 45 to 200 m²/g, preferably 45 to 180 m²/g, still preferably 50 to 180 m²/g. The DBP (dibutyl phthalate) absorption is usually 5 to 100 ml/100 g, preferably 10 to 80 ml/100 g, still preferably 20 to 60 ml/100 g. The specific gravity is usually 2.0 to 7.5, preferably 3 to 7. The particle shape may be any of needle-like, spherical, polygonal and platy shapes. The SA (stearic acid) adsorption is usually 1 to 20 μmol/m², preferably 2 to 15 μmol/m², still preferably 3 to 8 μmol/m².

Nonmagnetic powder having a high SA adsorption is preferably pretreated with an organic substance that is strongly adsorbable onto the surface of the powder, which is effective to reduce the frictional coefficient of the magnetic recording medium. It is preferred that the nonmagnetic powder be surface treated with an Al, Mg, Si, Ti, Zr, Sn, Sb, Zn or Y compound. Preferred treating compounds for improving dispersibility are Al₂O₃, SiO₂, TiO₂, ZrO₂, and MgO, and hydrates thereof, with Al₂O₃, SiO₂, and ZrO₂, and their hydrates being still preferred. These oxides may be used either individually or in combination. According to the purpose, a composite surface layer can be formed by co-precipitation or a method comprising first applying alumina to the nonmagnetic particles and then treating with silica or vise versa. The surface layer may be porous for some purposes, but a homogeneous and dense surface layer is generally preferred.

Specific examples of commercially available nonmagnetic powders that can be used in the nonmagnetic layer include α-iron oxide series DPN-250BX, DPN-245, DPN-270BX, DPN-550BX, DBN-550RX, DBN-650RX, and DAN-850RX from Toda Kogyo Corp.; titanium oxide series TTO-51A and TTO-S (from Ishihara Sangyo Kaisha, Ltd.; titanium oxide series MT-100S, MT-100T, MT-150W, MT-500B, MT-100F, and MT-500HD from Tayca Corp.; FINEX-25, BF-1, BF-10, BF-20, and ST-M from Sakai Chemical Industry Co., Ltd.; and iron oxide series DEFIC-Y and DEFIC-R and sintered products thereof from Dowa Mining Co., Ltd.

Carbon black can be incorporated into the lower nonmagnetic layer to reduce surface resistivity and light transmission and also to obtain a desired micro Vickers hardness. Addition of carbon black is also effective in holding the lubricant. Useful carbon black species include furnace black for rubber, thermal black for rubber, carbon black for colors, conducting carbon black, and acetylene black. The characteristics of carbon black to be used, such as those described below, should be optimized according to an intended effect. Combined use of different kinds of carbon black can bring about enhancement of the effects.

The carbon black in the lower layer usually has a specific surface area (S_{BET}) of 50 to 500 m²/g, preferably 70 to 400 m²/g, a DBP absorption of 20 to 400 ml/100 g, preferably 30 to 400 ml/100 g, and an average particle size of 5 to 80 nm, preferably 10 to 50 nm, still preferably 10 to 40 nm. The carbon black preferably has a pH of 2 to 10, a water content of 0.1% to 10% by weight, and a tap density of 0.1 to 1 g/ml.

Specific examples of commercially available carbon black which can be used in the lower layer include Black Pearls 2000, 1300, 1000, 900, 800, 880, and 700, and Vulcan XC-72 from Cabot Corp.; #3050B, #3150B, #3750B, #3950B, #950, #650B, #970B, #850B, MA-600, MA-230, #4000, and #4010 from Mitsubishi Chemical Corp.; Conductex SC and RAVEN 8800, 8000, 7000, 5750, 5250, 3500, 2100, 2000, 1800, 1500, 1255, and 1250 from Columbian Carbon; and Ketjen Black EC from Ketjen Black International Co.). Carbon black having been surface treated with a dispersant, etc., resin-grafted carbon black, or carbon black with its surface partially graphitized may be used. Carbon black may previously been dispersed in a binder before being mixed into a coating composition. The carbon black is used in an amount of 50% by weight or less based on the nonmagnetic powder and 40% by weight or less based on the total weight of the nonmagnetic layer. The above-recited carbon black species can be used either individually or as a combination thereof. In selecting carbon black species for use in the present invention, reference can be made, e.g., in Carbon Black Kyokai (ed.), Carbon Black Binran.

The lower layer can contain organic powder according to the purpose. Useful organic powders include acrylic-styrene resin powders, benzoguanamine resin powders, melamine resin powders, and phthalocyanine pigments. Polyolefin resin powders, polyester resin powders, polyamide resin powders, polyimide resin powders, and polyethylene fluoride resin powders are also usable. Methods of preparing these resin powders are disclosed, e.g., in JP-A-62-18564 and JP-A-60-255827.

With respect to the kinds and amounts of binder resins, lubricants, dispersants, additives, and solvents, dispersing methods used in the formation of the nonmagnetic layer, the conventional relevant techniques used in the formation of the magnetic layer apply.

An abrasive, which can also serve as a reinforcing agent, can be added to the nonmagnetic layer. Known abrasives mostly having a Mohs hardness of 6 or higher can be used in the present invention. Such abrasives include α-alumina having an α-phase content of 90% or more, β-alumina, silicon carbide, chromium oxide, cerium oxide, α-iron oxide, corundum, silicon nitride, titanium carbide, titanium oxide, silicon dioxide, and boron nitride. These abrasives can be used either individually or as a mixture thereof or as a composite thereof (an abrasive surface treated with another). Existence of impurity compounds or elements, which are sometimes observed in the abrasives, will not affect the effect as long as the content of the main component is 90% by weight or higher. The abrasive grains preferably have an average size of 0.01 to 1 μm. In order to improve electromagnetic characteristics, in particular, it is desirable for the abrasive grains to have a narrow size distribution. In order to improve durability, abrasives different in grain size may be used in combination, or a single kind of an abrasive having a broadened size distribution may be used to produce the same effect. The abrasive preferably has a tap density of 0.3 to 1.5 g/ml, a water content of 0.1% to 5% by weight, a pH of 3 to 11, and a specific surface area (S_{BET}) of 5 to 50 m²/g. The abrasive grains may be needle-like, spherical or cubic. Angular grains are preferred for high abrasive performance.

Specific examples of commercially available abrasives that can be used in the nonmagnetic layer are AKP-10, AKP-15, AKP-20, AKP-30, AKP-50, HIT-50, HIT-60A, HIT-60G, HIT-70, HIT-80, HIT-82, HIT-100, and Sumicorundum series AA-01, AA-03, AA-04 and AA-06 from Sumitomo Chemical Co., Ltd.; ERC-DBM, HP-DBM, and HPS-DBM from Reynolds Metals Co.; WA10000 from Fujimi Kenmazai K.K. ; UB 20 from Uyemura & CO., LTD; G-5, Chromex U2, and Chromex U1 from Nippon Chemical Industrial Co., Ltd.; TF100 and TF140 from Toda Kogyo Corp.; Beta-Random Ultrafine from Ibiden Co., Ltd.; and B-3 from Showa Mining Co., Ltd.

Incorporating the abrasive into the lower layer allows for controlling the surface profile or the projecting conditions of the abrasive grains on the coating layer. Needless to say, the grain size and the amount of the abrasive added to the lower layer should be optimized.

Conventionally known thermoplastic resins, thermosetting resins and reactive resins, and mixtures thereof can be used as a binder in the magnetic layer and the nonmagnetic layer. Thermoplastic resins used as a binder generally have a glass transition temperature of −100° to 150° C., an number average molecular weight of 1,000 to 200,000, preferably 10,000 to 100,000, and a degree of polymerization of about 50 to 1000. Examples of such thermoplastic resins include homo- or copolymers containing a unit derived from vinyl chloride, vinyl acetate, vinyl alcohol, maleic acid, acrylic acid, an acrylic ester, vinylidene chloride, acrylonitrile, methacrylic acid, a methacrylic ester, styrene, butadiene, ethylene, vinyl butyral, vinyl acetal, a vinyl ether, etc.; polyurethane resins, and various rubber resins. Examples of useful thermosetting resins and reactive resins include phenolic resins, epoxy resins, thermosetting polyurethane resins, urea resins, melamine resins, alkyd resins, reactive acrylic resins, formaldehyde resins, silicone resins, epoxy-polyamide resins, polyester resin/isocyanate prepolymer mixtures, polyester polyol/polyisocyanate mixtures, and polyurethane/polyisocyanate mixtures. For the details of these resin binders, Plastic Handbook published by Asakura Shoten can be referred to. Known EB-curing resins can also be used in each layer. The details of the EB-curing resins and methods of producing them are described in JP-A-62-256219. The above-recited resins can be used either individually or as a combination thereof. Preferred resins are a combination of a polyurethane resin and at least one resin selected from polyvinyl chloride, a vinyl chloride-vinyl acetate copolymer, a vinyl chloride-vinyl acetate-vinyl alcohol copolymer, a vinyl chloride-vinyl acetate-maleic anhydride copolymer (hereinafter inclusively referred to as a vinyl chloride resin), and an acrylic resin, and a combination of the above-described combination and polyisocyanate.

The polyurethane resin can have known structures, such as polyester polyurethane, polyether polyurethane, polyether polyester polyurethane, polycarbonate polyurethane, polyester polycarbonate polyurethane, and polycaprolactone polyurethane. In order to enhance dispersing capabilities and durability, it is preferred to introduce into the above-recited binder resins at least one polar group by copolymerization or through addition reaction, the polar group being selected from —COOM, —SO₃M, —OSO₃M, —P═O(OM)₂, —O—P═O(OM)₂ (wherein M is a hydrogen atom or an alkali metal), OH, NR₂, N⁺R₃ (wherein R is a hydrocarbon group), an epoxy group, SH, CN, and the like. The amount of the polar group to be introduced is 10⁻¹ to 10⁻⁸ mol/g, preferably 10⁻² to 10⁻⁶ mol/g.

Examples of commercially available binder resins which can be used in the invention are VAGH, VYHH, VMCH, VAGF, VAGD, VROH, VYES, VYNC, VMCC, XYHL, XYSG, PKHH, PKHJ, PKHC, and PKFE from Union Carbide Corp.; MPR-TA, MPR-TA5, MPR-TAL, MPR-TSN, MPR-TMF, MPR-TS, MPR-TM, and MPR-TAO from Nisshin Chemical Industry Co., Ltd.; 1000w, DX80, DX81, DX82, DX83, and 100FD from Denki Kagaku Kogyo K.K.; MR-104, MR-105, MR110, MR100, MR555, and 400X-110A from Zeon Corp.; Nipporan series N2301, N2302, and N2304 from Nippon Polyurethane Industry Co., Ltd.; Pandex series T-5105, T-R3080, and T-5201, Barnock series D-400 and D-210-80, and Crisvon series 6109 and 7209 from Dainippon Ink & Chemicals, Inc.; Vylon UR series 8200, 8300, and 8700, RV530, and RV280 from Toyobo Co., Ltd.; Daiferamin series 4020, 5020, 5100, 5300, 9020, 9022, and 7020 from Dainichiseika Color & Chemicals Mfg. Co., Ltd.; MX5004 from Mitsubishi Chemical Corp.; Sanprene SP-150 from Sanyo Chemical Industries, Ltd.; and Saran F series 310 and 210 from Asahi Chemical Industry Co., Ltd.

Examples of the polyisocyanate that can be used in the binder formulation includes tolylene diisocyanate, 4,4′-diphenylmethane diisocyanate, hexamethylene diisocyanate, xylylene diisocyanate, naphthylene-1,5-diisocyanate, o-toluidine diisocyanate, isophorone diisocyanate, and triphenylmethane triisocyanate. Further included are reaction products between these isocyanate compounds and polyols and polyisocyanates produced by condensation of the isocyanates. Examples of commercially available polyisocyanates useful in the invention are Coronate L, Coronate HL, Coronate 2030, Coronate 2031, Millionate MR, and Millionate MTL from Nippon Polyurethane Industry Co., Ltd.; Takenate D-102, Takenate D-110N, Takenate D-200, and Takenate D-202 from Takeda Chemical Industries, Ltd.; and Desmodur L, Desmodur IL, Desmodur N, and Desmodur HL from Sumitomo Bayer Urethane Co., Ltd. They can be used in each layer, either alone or as a combination of two or more thereof taking advantage of difference in curing reactivity.

The binder is used in the nonmagnetic layer and the magnetic layer in an amount of 5% to 50% by weight, preferably 10% to 30% by weight, based on the nonmagnetic powder or the magnetic powder or the total weight of the magnetic powder and nonmagnetic powder, respectively. When a vinyl chloride resin, a polyurethane resin, and polyisocyanate are used in combination, their amounts are selected from a range of 5% to 30% by weight, a range of 2% to 20% by weight, and a range of 2% to 20% by weight, respectively. In case where head corrosion by a trace amount of released chlorine is expected to occur, polyurethane alone or a combination of polyurethane and polyisocyanate can be used. The polyurethane to be used preferably has a glass transition temperature of −50° to 150° C., preferably 0° to 100° C., an elongation at break of 100% to 2000%, a stress at rupture of 0.05 to 10 kg/mm² (0.49 to 98 Mpa), and a yield point of 0.05 to 10 kg/mm² (0.49 to 98 Mpa).

The magnetic recording medium of the present invention has at least two layers on the substrate, the lower nonmagnetic layer and the upper magnetic layer. These layers can have different binder formulations in terms of the binder content, the proportions of a vinyl chloride resin, a polyurethane resin, polyisocyanate, and other resins, the molecular weight of each resin, the amount of the polar group introduced, and other physical properties of the resins. It is rather desirable to optimize the binder design for each layer. For the optimization, known techniques relating to a nonmagnetic/magnetic multilayer structure can be utilized. For example, to increase the binder content of the magnetic layer is effective to reduce scratches on the magnetic layer, or to increase the binder content of the nonmagnetic layer is effective to increase flexibility thereby to smooth head touch.

An abrasive can be added to the magnetic layer to provide the magnetic layer with a head cleaning effect and improved strength. It is desirable for the abrasive added to the magnetic layer to have an average grain size of 0.01 to 0.25 μm and a Mohs hardness of 5 or higher. Known abrasives mostly having a Mohs hardness of 5 or higher can be used in the magnetic layer. Examples are α-alumina having an α-phase content of 90% or more, β-alumina, silicon carbide, chromium oxide, cerium oxide, α-iron oxide, corundum, silicon nitride, titanium carbide, titanium oxide, silicon dioxide, and boron nitride. These abrasives can be used either individually or as a mixture thereof or as a composite thereof (an abrasive surface treated with another). Existence of impurity compounds or elements, which are sometimes observed in the abrasives, will not affect the effect as long as the content of the main component is 90% by weight or higher. To improve electromagnetic characteristics, it is desirable for the abrasive to have a narrow size distribution.

To improve durability, abrasives different in grain size may be used in combination, or a single kind of an abrasive having a broadened size distribution may be used to produce the same effect. The abrasive preferably has a tap density of 0.3 to 1.5 g/ml, a water content of 0.1% to 5% by weight, a pH of 3 to 11, and a specific surface area (SBET) of 10 to 80 m²/g. The abrasive grains may be needle-like, spherical or cubic. Angular grains are preferred for high abrasive performance. Examples of commercially available abrasives that can be used in the magnetic layer are AKP-30, AKP-50, AKP-80, AKP-100, HIT-50, HIT-60A, HIT-60G, HIT-70, HIT-80, HIT-82, HIT-100, and Sumicorundum AA-03 from Sumitomo Chemical Co., Ltd.; UB 40B from Uemura & CO., LTD.; micron sized diamond powders (graded 0-1/4, 0-1/6 or 0-1/8) available from Tomei Diamond Co., Ltd., Lands Superabrasives Co., E. I. du Pont, General Electric Co., etc.; and TF100, TF140, and TF180 from Toda Kogyo Corp.

While abrasives having an average grain size of 0.01 to 0.5 μm are effective, an average grain size of 0.01 to 0.25 μm is advisable for use in the magnetic layer from the standpoint of surface roughness and surface defects of the medium. An average grain size of 0.02 to 0.15 μm is still preferred. The abrasives are preferably used in a total amount of 1 to 20 parts by weight, still preferably 1 to 15 parts by weight, per 100 parts by weight of the ferromagnetic powder to ensure sufficient durability and to improve surface properties and packing density. The abrasives may previously be dispersed in a binder or a dispersant before being mixed into a magnetic coating composition.

The magnetic layer and the nonmagnetic layer can contain other additives capable of producing lubricating effects, antistatic effects, dispersing effects, plasticizing effects, and the like. Examples of useful additives include molybdenum disulfide, tungsten disulfide, graphite, boron nitride, graphite fluoride, silicone oils, polar group-containing silicones, fatty acid-modified silicones, fluorine-containing silicones, fluorine-containing alcohols, fluorine-containing esters, polar group-containing perfluoropolyethers, polyolefins, polyglycols, alkylphosphoric esters and alkali metal salts thereof, alkylsulfuric esters and alkali metal salts thereof, polyphenyl ethers, phenylphosphonic acid, α-naphtylphosphoricacid, phenylphosphoricacid, diphenylphosphoric acid, p-ethylbenzenephosphonic acid, phenylphosphinic acid, aminoquinones, various silane coupling agents, titan coupling agents, fluorine-containing alkylsulfuric esters and their alkali metal salts, saturated or unsaturated, straight-chain orbranchedmonobasic fatty acids having 10 to 24 carbon atoms and their metal (e.g., Li, Na, K, Cu) salts, saturated or unsaturated, straight-chain or branched mono-to hexahydric alcohols having 12 to 22 carbon atoms, alkoxyalcohols having 12 to 22 carbon atoms, mono-, di- or tri-fatty acid esters between saturated or unsaturated, straight-chain or branched monobasic fatty acids having 10 to 24 carbon atoms and at least one of mono- to hexahydric, saturated or unsaturated, and straight-chain or branched alcohols having 2 to 12 carbon atoms, fatty acid esters of polyalkylene oxide monoalkyl ethers, fatty acid amides having 8 to 22 carbon atoms, and aliphatic amines having 8 to 22 carbon atoms.

Examples of the fatty acids are capric acid, caprylic acid, lauric acid, myristic acid, palmitic acid, stearic acid, behenic acid, oleic acid, elaidic acid, linoleic acid, linolenic acid, and isostearic acid. Examples of the esters are butyl stearate, octyl stearate, amyl stearate, isooctyl stearate, butyl myristate, octyl myristate, butoxyethyl stearate, butoxydiethyl stearate, 2-ethylhexyl stearate, 2-octyldodecyl palmitate, 2-hexyldodecyl palmitate, isohexadecyl stearate, oleyl oleate, dodecyl stearate, tridecyl stearate, oleyl erucate, neopentyl glycol didecanoate, and ethylene glycol dioleate. Examples of the alcohols are oleyl alcohol, stearyl alcohol, and lauryl alcohol.

The magnetic layer and the nonmagnetic layer can contain surface active agents. Examples of useful surface active agents include nonionic ones, such as alkylene oxide types, glycerol types, glycidol types, and alkylphenol ethylene oxide adducts; cationic ones, such as cyclic amines, ester amides, quaternary ammonium salts, hydantoin derivatives, heterocyclic compounds, phosphonium salts, and sulfonium salts; anionic ones containing an acidic group, such as a carboxyl group, a sulfonic acid group, a phosphoric acid group, a sulfuric ester group or a phoshoric ester group; and amphoteric ones, such as amino acids, aminosulfonic acids, amino alcohol sulfuric or phosphoric esters, and alkyl betaines.

For the details of the surface active agents, refer to Kaimen Kasseizai Binran published by Sangyo Tosho K.K. The lubricants, surface active agents, and like additives do not always need to be 100% pure and may contain impurities, such as isomers, unreacted materials, by-products, decomposition products, and oxidation products. Nevertheless, the proportion of the impurities is preferably 30% by weight at the most, still preferably 10% by weight or less.

Since the physical actions of these additives vary among individuals, the kind and amount of an additive or the mixing ratio of additives used in combination for producing a synergistic effect should be determined so as to produce optimum results according to the purpose. The following is a few examples of possible manipulations using additives. (1) Bleeding of fatty acid additives is suppressed by using fatty acids having different melting points between the magnetic layer and the nonmagnetic layer. (2) Bleeding of ester additives is suppressed by using esters different in boiling point, melting point or polarity between the magnetic layer and the nonmagnetic layer. (3) Coating stability is improved by adjusting the amount of a surface active agent. (4) The amount of the lubricant in the nonmagnetic layer is increased to improve the lubricating effect. The total amount of the lubricants to be used in the magnetic or nonmagnetic layer is generally selected from a range of 0.1% to 50% byweight, preferably 2% to 25% by weight, based on the magnetic or nonmagnetic powder.

All or part of the additives can be added at any stage of preparing the magnetic or nonmagnetic coating composition. For example, the additives can be blended with the magnetic powder before kneading, be mixed with the magnetic powder, the binder, and a solvent in the step of kneading, or be added during or after the step of dispersing or immediately before coating. The purpose of using an additive could be achieved by separately applying a part of, or the whole of, the additive on the magnetic layer surface either by simultaneous coating or successive coating, which depends on the purpose. A lubricant could be applied to the magnetic layer surface even after calendering or slitting, which depends on the purpose.

Known organic solvents, e.g., those described in JP-A-6-68453, can be used in the preparation of magnetic and nonmagnetic coating compositions.

The thickness of the nonmagnetic substrate that can be used in the invention generally ranges from 2.5 to 100 μm. More specifically, the thickness of the substrate for tapes is preferably 2.5 to 10 μm, still preferably 3.0 to 8 μm, in order to secure a large volume density, and that for disks is preferably 20 to 100 μm, still preferably 25 to 80 μm.

An undercoat layer for adhesion enhancement may be provided between the substrate and the nonmagnetic layer. The undercoat layer usually has a thickness of 10 to 500 nm, preferably 20 to 300 nm. In this case, a backcoat layer may be provided on the side opposite to the magnetic layer side for static prevention and curling correction. The backcoat layer usually has a thickness of 0.1 to 2.0 μm, preferably 0.3 to 1.0 μm. The undercoat layer and the backcoat layer can be of known materials.

The thickness of the magnetic layer is 25 to 150 nm, preferably 25 to 100 nm, still preferably 25 to 90 nm, while it is to be optimized according to the saturation magnetization and the gap length of a head used and the wavelength range of recording signals. With the magnetic layer's thickness being in that range, the magnetic layer has uniformity, the self demagnetization reduces, the transition noise reduces, and the resolution increases.

The magnetic layer may be divided into two or more sublayers different in magnetic characteristics. Known techniques relating to a multilayered magnetic layer apply to that structure.

The thickness of the nonmagnetic layer ranges 0.5 to 2.5 μm, preferably 0.5 to 2.0 μm, still preferably 0.6 to 2.0 μm. The lower nonmagnetic layer manifests the essentially expected effects as long as it is substantially nonmagnetic. In other words, the effects of the lower layer are produced even when it contains a small amount of a magnetic substance, either intentionally or unintentionally. Such a layer formulation is construed as being included under the scope of the present invention. The term “substantially nonmagnetic” as referred to above means that the lower layer has a residual magnetic flux density of 50 mT or less or a coercive force of not more than 40% of that of the upper magnetic layer. Preferably, both the residual magnetic flux density and coercive force of the lower layer are zero.

The magnetic recording medium of the invention preferably has a backcoat layer on the opposite side of the substrate to the magnetic layer. The backcoat layer preferably contains carbon black and inorganic powder. The binder and additive formulations for the magnetic and nonmagnetic layers also apply to the backcoat layer. The thickness of the backcoat layer is preferably 0.9 μm or less, still preferably 0.1 to 0.7 μm.

The substrates that can be used in the invention include films of known materials, such as polyesters (e.g., polyethylene terephthalate and polyethylene naphthalate), polyolefins, cellulose triacetate, polycarbonate, polyamides (including aliphatic polyamides and aromatic polyamides, e.g., aramid), polyimide, polyamideimide, polysulfone, and polybenzoxazole. High strength substrates of polyethylene naphthalate or aramid are preferred. If desired, a laminated substrate, such as the one disclosed in JP-A-3-224127, can be used to provide different surface profiles between the magnetic layer side and the back side. The substrate may previously be subjected to surface treatment, such as a corona discharge treatment, a plasma treatment, an adhesion enhancing treatment, a heat treatment, and a cleaning treatment. An alumina or glass substrate could also be employed.

In order to accomplish the object of the invention, it is desirable to use a substrate having a three dimensional average surface roughness (SRa) of 6.0 nm or smaller, preferably 4.0 nm or smaller, still preferably 2.0 nm or smaller, as measured with a three dimensional profiler TOPO-3D supplied by Wyko. It is desirable for the substrate to have not only a small surface roughness but no projections of 0.5 μm or higher. The surface profile is controlled as desired by the size and amount of fillers added to the substrate where necessary. Useful fillers include oxides and carbonates of Ca, Si, Ti, etc. and organic fine powders of acrylic resins, etc. The surface profile of the substrate preferably has a maximum height SRₘₐₓ of 1 μm or smaller, a 10 point average roughness SR_{z} of 0.5 μm or smaller, a maximum peak-to-mean plane height SRₚ of 0.5 μm or smaller, a maximum mean plane-to-valley depth SRᵥ of 0.5 μm or smaller, a mean plane area ratio SSr of 10% to 90%, and an average wavelength Sλₐ of 5 to 300 μm. The projection distribution on the substrate surface can be controlled freely by the filler to obtain desired electromagnetic characteristics and durability. The number of projections of 0.01 to 1 μm per 0.1 mm² is controllable between 0 and 2000. Providing a smoothing layer on the substrate to control the surface roughness of the substrate is also preferred.

The substrate preferably has an F5 value of 5 to 50 kg/mm² (49 to 490 Mpa), a thermal shrinkage of 3% or less, still preferably 1.5% or less, at 100° C.×30 minutes and of 1% or less, still preferably 0.5% or less, at 80° C.×30 minutes, a breaking strength of 5 to 100 kg/mm² (49 to 980 MPa), an elastic modulus of 100 to 2000 kg/mm² (980 to 19600 MPa), a coefficient of temperature expansion of 10⁻⁴ to 10⁻⁸/° C., still preferably 10⁻⁵ to 10⁻⁶/° C., and a coefficient of humidity expansion of 10⁻⁴/RH % or less, still preferably 10⁻⁵/RH % or less. It is desirable for the substrate to be isotropic such that the differences in these thermal, dimensional, and mechanical characteristics in all in-plane directions are within 10%.

Methods of preparing the magnetic and nonmagnetic coating compositions include at least the steps of kneading and dispersing and, if desired, the step of mixing which is provided before or after the step of kneading and/or the step of dispersing. Each step may be carried out in two or more divided stages. Any of the materials, including the magnetic powder, nonmagnetic powder, binder, abrasive, conductive powder, antistatic, lubricant, and solvent, can be added at the beginning of or during any step. Individual materials may be added in divided portions in two or more steps. For example, polyurethane may be added dividedly in the kneading step, the dispersing step, and a mixing step provided for adjusting the viscosity of the dispersion. To accomplish the object of the invention, known techniques for coating composition preparation can be applied as a part of the method. The kneading step is preferably performed using a kneading machine with high kneading power, such as an open kneader, a continuous kneader, a pressure kneader, and an extruder. In using a kneader, the magnetic or nonmagnetic powder is kneaded with a part (preferably at least 30% by weight of the total binder) or the whole of the binder and 15 to 500 parts by weight of a solvent per 100 parts by weight of the magnetic or nonmagnetic powder. For the details of the kneading operation, reference can be made in JP-A-1-106338 and JP-A-1-79274. In the step of dispersing, glass beads can be used to disperse the magnetic or nonmagnetic mixture. High-specific-gravity dispersing beads, such as zirconia beads, titania beads, and steel beads are suitable. The size and mixing ratio of the dispersing beads should be optimized. Known dispersing machines can be used. The magnetic powder, abrasive, conductive powder, etc. that show different rates of dispersing may be separately dispersed, and the resulting dispersions are mixed up and, if needed, more finely dispersed to prepare a coating composition.

The magnetic recording medium of the present invention has a multilayer structure containing at least two layers on a substrate, which effectively contributes to achievement of high recording density. After the nonmagnetic coating composition applied to the substrate is dried to form a lower nonmagnetic layer, a dispersion containing filler particles having an average diameter of 4 to 14 nm is applied to the nonmagnetic layer and dried. A magnetic layer is then formed thereon. If desired, the magnetic layer may be provided after the web of the substrate having the nonmagnetic layer and the dried coat of the dispersion is once taken up in a roll form and calendered. In the case where the filler particle dispersion contains, as a binder, a compound polymerizable upon irradiation with high energy rays, the dispersion applied is caused to react by irradiation with high energy rays either after being dried or after being calendered. The process of the invention can be embodied by, for example, the following coating techniques.

(a) A method comprising applying a nonmagnetic coating composition by means of a coating apparatus generally employed for a magnetic coating composition, such as a gravure coater, a roll coater, a blade coater or an extrusion coater, drying the coating film to form a lower nonmagnetic layer, applying a filler particle dispersion by, for example, bar coating, and applying a magnetic coating composition by means of the extrusion coating apparatus disclosed in JP-B 1-46186, JP-A-60-238179, and JP-A-2-265672 while scraping the applied coating to a predetermined thickness.

(b) A method comprising applying a nonmagnetic coating composition by means of a coating apparatus generally employed for a magnetic coating composition, such as a gravure coater, a roll coater, a blade coater or an extrusion coater, drying the coating film to form a lower nonmagnetic layer, applying a filler particle dispersion by, for example, bar coating, and applying a magnetic coating composition by means of the coating head disclosed in JP-A-63-88080, JP-A-2-17971, and JP-A-2-265672. The coating head has two slits through which liquid may pass. The magnetic coating composition is applied through the front slit, and the applied coating composition is sucked up through the rear slit to leave a prescribed coating thickness.

In carrying out the process of the invention, it is desirable to take care in selecting the binder resins and solvents to be used in the lower and upper layers so that the lower layer may not be denatured on applying the magnetic coating composition.

Calendering of the lower nonmagnetic layer or the upper magnetic layer is carried out with metallic rolls or rolls of heat-resistant plastics, such as epoxy resins, polyimide, polyamide and polyimide-amide. Calendering between metallic rolls is preferred in making a double-sided magnetic recording medium. The calendering temperature is preferably 50° C. or higher, still preferably 100° C. or higher. The linear pressure of calender rolls is preferably 200 kg/cm (196 kN/m) or higher, still preferably 225 to 300 kg/cm (220 to 294 kN/m), so as to fluidize an excess of the binder thereby to reduce the frictional coefficient and prevent head clogging.

The magnetic recording medium of the invention has a frictional coefficient of 0.5 or less, preferably 0.3 or less, against a head at temperatures of −10° to 40° C. and humidities of 0% to 95%. The surface resistivity on the magnetic surface is preferably 10⁴ to 10¹² Ω/sq. The static potential is preferably −500 to +500 V. The magnetic layer preferably has an elastic modulus at 0.5% elongation of 100 to 2000 kg/mm² (980 to 19600 N/mm²) in every in-plane direction and a breaking strength of 10 to 70 kg/mm² (98 to 686 N/mm²). The magnetic recording medium preferably has an elastic modulus of 100 to 1500 kg/mm² (980 to 14700 N/mm²) in every in-plane direction, a residual elongation of 0.5% or less, and a thermal shrinkage of 1% or less, more preferably 0.5% or less, even more preferably 0.1% or less, at temperatures of 100° C. or lower. The glass transition temperature (maximum loss elastic modulus in dynamic viscoelasticity measurement at 110 Hz, measured with a viscoelastometer, e.g., Rheovibron) of the magnetic layer is preferably 50° to 120° C., and that of the nonmagnetic lower layer is preferably 0° to 100° C. The loss elastic modulus preferably ranges from 1×10³ to 8×10⁴ N/cm². The loss tangent is preferably 0.2 or lower. Too high a loss tangent easily leads to a tack problem. It is desirable that these thermal and mechanical characteristics be substantially equal in all in-plane directions with differences falling within 10%. The residual solvent content in the magnetic layer is preferably 100 mg/M² or less, still preferably 10 mg/m² or less. The magnetic layer and the nonmagnetic layer each preferably have a void of 30% by volume or less, still preferably 20% by volume or less. While a lower void is better for high output, there are cases in which a certain level of void is recommended in some applications.

With respect to the 3D surface profile of the magnetic layer as measured with TOPO-3D (Wyko), the average surface roughness SRa (arithmetic average of the height deviation from the mean plane) is preferably 2.7 nm or less, still preferably 2.5 nm or less, even still preferably 2.0 nm or less. The 3D surface profile preferably has a maximum height Sₘₐₓ of 0.5 μm or smaller, a 10 point average roughness S_{z} of 0.3 μm or smaller, a maximum mean plane-to-peak height Sₚ of 0.3 μm or smaller, a maximum mean plane-to-valley depth Sᵥ of 0.3 μm or smaller, a mean plane area ratio Sr of 20% to 80%, and an average wavelength Sλₐ of 5 to 300 μm. The number of projections of 0.01 to 1 μm per 0.1 mm² of the magnetic layer is controllable as desired between 0 and 2000. It is preferred to control the projection distribution on the magnetic layer to optimize the electromagnetic characteristics and the frictional coefficient of the magnetic recording medium. These surface profile parameters of the magnetic layer are easily controlled by controlling the surface profile of the substrate (which can be done by means of a filler as previously mentioned), by adjusting the size and amount of powders used in the magnetic layer, and by selecting the surface profile of calendering rolls. Curling of the magnetic recording medium is preferably within ±3 mm.

In the case of a dual layer structure as in the present invention, it is easily anticipated that the physical properties are varied between the lower nonmagnetic layer and the upper magnetic layers according to the purpose. For example, the elastic modulus of the magnetic layer can be set relatively high to improve running durability, while that of the nonmagnetic layer can be set relatively low to improve head contact.

The particle size of various powders used in the invention including ferromagnetic metal powder, hexagonal ferrite powder, and carbon black is measured from high-resolution transmission electron micrographs with the aid of an image analyzer. The outline of particles on micrographs is traced with the image analyzer to obtain the particle size. The particle size is represented by (1) the length of a major axis where a particle is needle-shaped, spindle-shaped or columnar (with the height greater than the maximum diameter of the base) like ferromagnetic metal powder, (2) a maximum diameter (length) of a main plane or a base where a particle is platy or columnar (with the thickness or height smaller than the maximum diameter of the base) like hexagonal ferromagnetic powder, or (3) a circle equivalent diameter where a particle is spherical, polygonal or amorphous and has no specific major axis. The “circle equivalent diameter” is calculated from a projected area.

The average particle size of powder is an arithmetic mean calculated from the particle sizes of about 400 to 500 primary particles measured as described above. The term “primary particles” denotes particles dependent of each other without agglomeration.

The term “average particle size” as used herein refers to the average length of particles having the shape identified in (1) above; the average diameter or length of particles having the shape identified in (2); or the average circle equivalent diameter of particles having the shape identified in (3). The average aspect ratio of powder is an arithmetic mean of length/breadth (major axis length/minor axis length) ratios of particles defined in (1) above or an arithmetic mean of length/thickness (diameter/thickness) ratios of particles defined in (2) above. The term “breadth” or “minor axis length” as used herein means the maximum length of axes perpendicular to the length or major axis of a particle defined in (1) or (2) above.

In connection to particle size distribution, the “coefficient of variation” is defined to be a percentage of standard deviation to mean.

The magnetic recording medium of the invention is preferably used to record at a maximum linear recording density of 200 kfci or higher and to reproduce the recorded signals with a GMR head. The shield gap length is 0.08 to 0.18 μm, and the read track width is 1 μm or smaller.

### EXAMPLES

The present invention will now be illustrated in greater detail with reference to Preparation Examples and Examples, but it should be understood that the invention is not construed as being limited thereto. Unless otherwise noted, all the percents and parts are by weight.

### (1) Preparation of Magnetic Layer Coating Composition 1

| | |
|---|---|
| Ferromagnetic metal powder | 100 parts |
| Hc: 185.5 kA/m; σs: 105 A · m²/kg; S_{BET}: 63 m²/g; | |
| average length: 45 nm; coefficient of length | |
| variation: 22%; composition: | |
| Fe/Co/Al/Y = 100/23/8.5/15 (atom %); sintering | |
| inhibitor: Al₂O₃ and Y₂O₃) | |
| Binder resin | |
| Vinyl chloride copolymer (—SO₃K content: | 13 parts |
| 1 × 10⁻⁴ eq/g; degree of polymerization: 300) | |
| Polyester polyurethane resin (neopentyl | |
| glycol/caprolactone | |
| polyol/diphenylmethane-4,4′-diisocyanate | 5 parts |
| (MDI) = 0.9/2.6/1 (by mole); —SO₃Na content: | |
| 1 × 10⁻⁴ eq/g) | |
| Alpha-alumina (average particle size: 0.11 μm) | 4 parts |
| Carbon black (average particle size: 40 nm; coefficient | 2.5 parts |
| of particle size variation: 200%) | |
| Phenylphosphonic acid | 3 parts |
| Butyl stearate | 3 parts |
| Stearic acid | 3 parts |
| Methyl ethyl ketone/cyclohexanone (1/1 by volume) | 280 parts |

The ferromagnetic metal powder, carbon black, and vinyl chloride copolymer were kneaded together with 130 parts (out of 280 parts) of the 1:1 mixed solvent of methyl ethyl ketone and cyclohexanone in a kneader. The rest of the above components were mixed therein, and the mixture was dispersed in a sand grinder together with zirconia beads of 0.5 mm in diameter. Six parts of polyisocyanate was added to the dispersion, and 20 parts of a 1:1 mixed solvent of methyl ethyl ketone and cyclohexanone was further added thereto, followed by filtration through a filter having an average opening size of 1 μm to prepare magnetic coating composition 1.

### (2) Preparation of Magnetic Coating Composition 2

| | |
|---|---|
| Hexagonal ferrite powder | 100 parts |
| (Hc: 175 kA/m; σs: 52.5 A · m²/kg; average plate | |
| diameter: 25.5 nm; coefficient of plate diameter | |
| variation: 22%; average aspect ratio: 3.8; S_{BET}: | |
| 55.4 m²/g; composition: | |
| Ba/Fe/Co/Zn/Nb = 8.5/100/0.9/4.4/1.9 (atom %)) | |
| Binder resin | |
| Vinyl chloride copolymer (—SO₃K content: | 11 parts |
| 1 × 10⁻⁴ eq/g; degree of polymerization: 300) | |
| Polyester polyurethane resin (neopentyl | 4.5 parts |
| glycol/caprolactone polyol/MDI = 0.9/2.6/1 (by | |
| mole); —SO₃Na content: 1 × 10⁻⁴ eq/g) | |
| Alpha-alumina (average particle size: 0.11 μm) | 10 parts |
| Carbon black (average particle size: 40 nm; coefficient | 2.0 parts |
| of particle size variation: 200%) | |
| Butyl stearate | 1.5 parts |
| Stearic acid | 2.5 parts |
| Methyl ethyl ketone/cyclohexanone (1/1 by volume) | 250 parts |

The hexagonal ferrite powder, carbon black, and vinyl chloride copolymer were kneaded together with 130 parts (out of 250 parts) of the 1:1 mixed solvent of methyl ethyl ketone and cyclohexanone in a kneader. The rest of the above components were mixed therein, and the mixture was dispersed in a sand grinder together with zirconia beads of 1 mm in diameter. Six parts of polyisocyanate was added to the dispersion, and 20 parts of a 1:1 mixed solvent of methyl ethyl ketone and cyclohexanone was further added thereto, followed by filtration through a filter having an average opening size of 1 μm to prepare magnetic coating composition 2.

### (3) Preparation of Magnetic Coating Composition 3

| | |
|---|---|
| Ferromagnetic metal powder containing Fe₁₆N₂ | 100 parts |
| (Hc: 209 kA/m; σs: 85 A · m²/kg; average diameter: | |
| 22 nm; coefficient of diameter variation: 23%; | |
| average aspect ratio: 1.05; S_{BET}: 52.1 m²/g; | |
| composition: Al/Y/V/Fe = 7.7/1.9/9.9/100 (atom %)) | |
| Binder resin | |
| Vinyl chloride copolymer (—SO₃K content: | 8 parts |
| 1 × 10⁻⁴ eq/g; degree of polymerization: 300) | |
| Polyester polyurethane resin (neopentyl | 4.5 parts. |
| glycol/caprolactone polyol/MDI = 0.9/2.6/1 (by | |
| mole); —SO₃Na content: 1 × 10⁻⁴ eq/g) | |
| Alpha-alumina (average particle size: 0.11 μm) | 10 parts |
| Carbon black (average particle size: 40 nm; coefficient | 2.0 parts |
| of particle size variation: 200%) | |
| Butyl stearate | 1.5 parts |
| Stearic acid | 2.5 parts |
| Methyl ethyl ketone/cyclohexanone (1/1 by volume) | 250 parts |

The Fe₁₆N₂ powder, carbon black, and vinyl chloride copolymer were kneaded together with 130 parts (out of 250 parts) of the 1:1 mixed solvent of methyl ethyl ketone and cyclohexanone in a kneader. The rest of the above components were mixed therein, and the mixture was dispersed in a sand grinder together with zirconia beads of 1 mm in diameter. Six parts of polyisocyanate was added to the dispersion, and 20 parts of a 1:1 mixed solvent of methyl ethyl ketone and cyclohexanone was further added thereto, followed by filtration through a filter having an average opening size of 1 μm to prepare magnetic coating composition 3.

### (4) Preparation of Nonmagnetic Coating Compositions 1 to 4 having formulation I

### Formulation I:

| | | |
|---|---|---|
| Acicular hematite (nonmagnetic powder shown in Table | 80 | parts |
| 1 below) | | |
| Carbon black (Conductex SC-U) | 20 | parts |
| Vinyl chloride copolymer (MR110 from Zeon Corp.) | 12 | parts |
| Polyurethane resin (UR8200 from Toyobo) | 5 | parts |
| Stearic acid | 3 | parts |
| Butyl stearate | 1 | part |
| Butoxyethyl stearate | 1 | part |
| Isohexadecyl stearate | 1 | part |
| Methyl ethyl ketone/cyclohexanone (8/2 by volume) | 250 | parts |

The hematite, carbon black, and vinyl chloride copolymer were kneaded together with 130 parts (out of 250 parts) of the 8:2 mixed solvent of methyl ethyl ketone and cyclohexanone in a kneader. The rest of the above components were mixed therein, and the mixture was dispersed in a sand grinder together with zirconia beads of 1 mm in diameter. Ten parts of polyisocyanate and 30 parts of cyclohexanone were added thereto. The resulting dispersion was filtered through a filter having an average opening size of 1 μm to prepare nonmagnetic coating compositions 1 to 4.

(5) Preparation of Nonmagnetic Coating Compositions 5 to 8 having formulation II

### Formulation II:

| | |
|---|---|
| Acicular hematite (nonmagnetic powder shown in Table | 80 parts |
| 1 below) | |
| Carbon black (Conductex SC-U) | 20 parts |
| Vinyl chloride copolymer (MR110 from Zeon Corp.) | 12 parts |
| Polyurethane resin (UR8200 from Toyobo) | 5 parts |
| Stearic acid | 3 parts |
| Butyl stearate | 10 parts |
| Butoxyethyl stearate | 5 parts |
| Isohexadecyl stearate | 3 parts |
| Methyl ethyl ketone/cyclohexanone (8/2 by volume) | 250 parts |

The hematite, carbon black, and vinyl chloride copolymer were kneaded together with 130 parts (out of 250 parts) of the 8:2 mixed solvent of methyl ethyl ketone and cyclohexanone in a kneader. The rest of the above components were mixed therein, and the mixture was dispersed in a sand grinder together with zirconia beads of 1 mm in diameter. Ten parts of polyisocyanate and 30 parts of cyclohexanone were added thereto. The resulting dispersion was filtered through a filter having an average opening size of 1 μm to prepare nonmagnetic coating compositions 5 to 8.

### (6) Preparation of Dispersions A to F Containing Filler Particles for Filling the Pores of Nonmagnetic Layer

| Filler (see Table 2 below) | X | parts |
|---|---|---|
| | | (see FIG. 2) |
| Dipentaerythritol pentaacrylate | 5 | parts |
| Cyclohexanone | 50 | parts |
| Methyl ethyl ketone | 50 | parts |

The above components were disposed in a sand grinder for 5 hours using zirconia beads having a diameter of 0.1 mm. The dispersion was filtered through a filter having an average opening size of 1 μm to prepare dispersions A to F.

### (7) Preparation of Backcoating Composition:

| | | |
|---|---|---|
| Carbon black (average particle size: 25 nm) | 40.5 | parts |
| Carbon black (average particle size: 370 nm) | 0.5 | parts |
| Barium sulfate | 4.05 | parts |
| Nitrocellulose | 28 | parts |
| Polyurethane resin (containing SO₃Na group) | 20 | parts |
| Cyclohexanone | 100 | parts |
| Toluene | 100 | parts |
| Methyl ethyl ketone | 100 | parts |

The above components were dispersed in a sand mill for a retention time of 45 minutes. To the dispersion was added 8.5 parts of polyisocyanate, followed by stirring and filtration to prepare a coating composition for a backcoat layer.

### Examples 1 to 14 and Comparative Examples 1 to 6

A nonmagnetic coating composition selected from nonmagnetic coating compositions 1 to 4 was applied to a 6.5 μm thick polyethylene terephthalate substrate film to a dry thickness of 2.0 μm and dried to form a nonmagnetic layer. A dispersion selected from dispersions A to F was applied to the nonmagnetic layer by coil bar coating while scraping off excessive dispersion with a doctor blade. The coating layer was dried and irradiated with an electron beam (acceleration voltage: 200 kV) at a dose of 50 kGy in a nitrogen atmosphere having an oxygen concentration of 200 ppm or less to cause the binder to cure. A magnetic coating composition selected from magnetic coating compositions 1 to 3 was applied thereon using a coating apparatus having a front slit and a rear slit. The coating composition was fed through the front slit to a wet thickness of 250 nm, and the excess of the coating composition applied was sucked up through the rear slit to give a dry coating thickness of 80 nm. While the magnetic layer was wet, it was longitudinally oriented by passing through a rare earth magnets (surface magnetic flux density: 500 mT) and then a solenoid magnet (magnetic fluxdensity: 500 mT). While passing through the solenoid, the coating layer was dried to such an extent that the magnetic powder might not be deoriented. The coated film was further dried in a drying zone and wound. The backcoating composition was applied to the opposite side of the substrate film and dried to form a backcoat layer. The coated film was passed through a 7-roll calender composed of metal rolls at a roll temperature of 90° C. to obtain a magnetic recording medium in web form, which was slit into ½ inch wide magnetic tapes.

The resulting magnetic tapes were measured for electromagnetic characteristics, magnetic characteristics, and surface roughness in accordance with the following methods. Separately, each of the nonmagnetic coating compositions 1 to 4 was applied to a 6.5 μm thick polyethylene terephthalate base film to the dry thickness of 2.0 μm to prepare samples for the measurement of specific surface area, pore volume, median pore radius, pore radius D10 and D90 in adsorption/desorption, and surface roughness of the nonmagnetic layer. The results of measurements are shown in Tables 1 and 3.

### Methods of Measurement:

### (1) Electromagnetic Characteristics

A drum tester equipped with a composite GMR head (write track width: 1.5 μm; read track width: 0.75 μm; shield gap length: 0.15 μm) was used. An optimum recording current was decided from the input/output characteristics in recording signals (λ=0.15 μm) at a relative tape running speed of 10.2 m/sec. Signals (λ=0.15 μm) were recorded on the magnetic tape at the optimum current and reproduced. The C/N was defined to be a ratio covering from reproduced carrier peak to demagnetization noise. The resolution band width of the spectral analyzer was set at 100 kHz. The output and the C/N of the samples using magnetic coating compositions 1, 2 or 3 were relatively expressed taking, as standards, the results of Comparative Examples 4, 5, and 6, respectively, in which the pores of the nonmagnetic layer surface were not filled.

### (2) Magnetic Characteristics

Magnetic characteristics were measured with a vibrating sample magnetometer in an applied magnetic field of 796 kA/m.

### (3) Thickness (δ) of Magnetic Layer

A resin embedded block of the magnetic tape was sectioned along the longitudinal direction of the tape on an ultramicrotome to prepare an ultrathin section of about 80 to 100 nm in thickness. The cut area of the magnetic tape of the section was photographed, approximately centered at the magnetic layer/nonmagnetic layer interface, under a transmission electron microscope (TEM H-9000 from Hitachi, Ltd.) at a magnification of 100,000 times serially over a length of 25 to 30 μm along the longitudinal direction of the tape. The surface of the magnetic layer and the interface between the magnetic layer and the nonmagnetic layer as visually defined were traced, and the outline of the magnetic layer was scanned into an image processor KS Imaging Systems ver. 3 from Carl Zeiss. The distance between the surface of the magnetic layer and the magnetic layer nonmagnetic layer interface was measured at about 2100 points for every 12.5 nm in the longitudinal direction of the tape to obtain an average magnetic layer thickness. Scaling in scanning and image analysis was corrected using a line of 2 cm in absolute length.

### (4) Surface Roughness of Magnetic Layer and Nonmagnetic Layer

The surface profile of a 250 μm side square of a sample was measured with a three-dimensional profiler TOPO-3D, supplied by Wyko. In computing the measured values, corrections such as tilt correction, spherical correction and cylindrical correction, were carried out in accordance with JIS B601. The parameter SRa was taken as a measure of surface roughness. The surface roughness of the nonmagnetic layer was measured using the above-described coated sample having only the nonmagnetic layer on the substrate.

### (5) Specific Area, Pore Volume, Median Pore Radius, and Adsorption/Desorption Pore Radius D10 and D90 of Nonmagnetic Layer

A specimen with an area of 300 to 600 cm² was cut out of the coated sample. The weight and thickness of the specimen were measured. After the specimen was degassed at room temperature for 5 hours, nitrogen adsorption/desorption isotherms were measured with an automatic gas adsorption analyzer AUTOSORB-1 from Quanta Chrome Inst. Co. at liquid-nitrogen temperature. The specific surface area per unit weight was calculated from the adsorption/desorption data according to multipoint BET method. The nitrogen adsorption/desorption isotherms were analyzed by the BJH method to obtain the pore size distribution, from which the pore volume per unit weight and the median pore radius were calculated. D10 and D90 were calculated from the cumulative curve of the pore distribution. The volume of the nonmagnetic layer was obtained from the area and thickness of the specimen (the substrate has no pores), and the specific surface area and the pore volume per unit weight were converted to those per unit volume (1 ml).

TABLE 1

| | | Characteristics of | | | | | | | | | | | |
|---|---|---|---|---|---|---|---|---|---|---|---|---|---|
| | | Hematite (1 wt % | | | Characteristics of Nonmagnetic Layer | | | | | | | | |
| Nonmagnetic | | Al-treated) | | | | | | Ads | Ads | Des | Des | | |
| Coating | | Avg | Avg | | | Pore | Median | Pore R | Pore R | Pore R | Pore R | | |
| Composition | | Length | Aspect | S_{BET} | S_{BET} | Volume | Pore | D10 | D90 | D10 | D90 | SRa | Thk |
| Designation | Formulation | (nm) | Ratio | (m²/g) | (m²/g) | (ml) | R (nm) | (nm) | (nm) | (nm) | (nm) | (nm) | (μm) |
| 1 | I | 155 | 6.5 | 53.1 | 22 | 0.17 | 15 | 11 | 25 | 7.3 | 11 | 5.2 | 2.0 |
| 2 | I | 110 | 6.1 | 54.5 | 62 | 0.35 | 14 | 9 | 22 | 6.2 | 10.5 | 5.1 | 2.0 |
| 3 | I | 69 | 5.8 | 95.7 | 108 | 0.36 | 7 | 4 | 12 | 3.9 | 6.9 | 5.2 | 2.0 |
| 4 | I | 66 | 5.6 | 57.5 | 73 | 0.36 | 11.5 | 7.8 | 16 | 5.3 | 8.5 | 4.8 | 2.0 |
| 5 | II | 155 | 6.5 | 53.1 | 52 | 0.33 | 13 | 7.1 | 23 | 6.1 | 13 | 5 | 1.8 |
| 6 | II | 110 | 6.1 | 54.5 | 28.3 | 0.21 | 15.1 | 10 | 21 | 4.1 | 5.8 | 5.3 | 1.8 |
| 7 | II | 69 | 5.8 | 95.7 | 71.1 | 0.27 | 8.1 | 4.5 | 12 | 5.6 | 7 | 5.3 | 1.8 |
| 8 | II | 66 | 5.6 | 57.5 | 29.8 | 0.18 | 13.3 | 8.4 | 16 | 6.3 | 12 | 4.8 | 1.8 |

Avg: average;
Ads: adsorption;
Des: desorption;
R: radius;
Thk: thickness

TABLE 2

| | | | | Amount | |
|---|---|---|---|---|---|
| | | Average | Variation | of | |
| | Kind of | Diameter | Coefficient | Filler X | Concentration |
| Dispersion | Filler | (nm) | (%) | (part) | (%) |
| A | SiO₂ | 5.0 | 5.2 | 3 | 2.7 |
| B | SiO₂ | 5.0 | 5.2 | 10 | 8.5 |
| C | SiO₂ | 9.5 | 4.7 | 5 | 4.3 |
| D | SiO₂ | 9.5 | 4.7 | 15 | 12.5 |
| E | SiO₂ | 9.5 | 4.7 | 20 | 16 |
| F | TiO₂ | 15.2 | 11.3 | 5 | 4.3 |

TABLE 3

| | | | | | Magnetic | | | | | |
|---|---|---|---|---|---|---|---|---|---|---|
| | Nonmagnetic | | Magnetic Layer | | Characteristics | | | | | |
| Example | Coating | Filler | Coating | Thickness δ | Hc | | Br · δ | SRa | Output | C/N |
| No. | Composition | Dispersion | Composition | (μm) | (kA/m) | SQ | (mT · μm) | (nm) | (dB) | (dB) |
| Ex 1 | 1 | A | 1 | 0.080 | 201.5 | 0.865 | 29.4 | 1.9 | 1.3 | 2.7 |
| Ex 2 | 1 | B | 1 | 0.080 | 201 | 0.860 | 29.3 | 2.0 | 1.3 | 2.7 |
| Ex 3 | 1 | C | 1 | 0.081 | 200.8 | 0.852 | 29.5 | 2.1 | 1.2 | 2.6 |
| Ex 4 | 1 | D | 1 | 0.081 | 200.7 | 0.851 | 29.3 | 2.1 | 1.0 | 2.5 |
| Ex 5 | 2 | B | 1 | 0.079 | 200.9 | 0.855 | 29.4 | 1.8 | 1.3 | 2.4 |
| Ex 6 | 2 | C | 1 | 0.080 | 200.5 | 0.849 | 29.5 | 1.9 | 1.2 | 2.5 |
| Ex 7 | 3 | B | 1 | 0.081 | 200.6 | 0.845 | 29.3 | 2.0 | 1.5 | 2.9 |
| Ex 8 | 4 | B | 1 | 0.081 | 200.5 | 0.848 | 29.7 | 1.9 | 1.4 | 2.8 |
| Comp Ex 1 | 1 | E | 1 | 0.082 | 200.2 | 0.833 | 29.4 | 2.6 | 0.5 | 0.5 |
| Comp Ex 2 | 1 | F | 1 | 0.081 | 200.4 | 0.831 | 29.2 | 3.0 | 0.3 | 0.4 |
| Comp Ex 3 | 3 | C | 1 | 0.082 | 200.1 | 0.835 | 29.4 | 2.6 | 0.9 | 0.7 |
| Comp Ex 4 | 1 | — | 1 | 0.079 | 200.3 | 0.841 | 29.4 | 2.7 | 0.0 | 0.0 |
| Ex 9 | 1 | A | 2 | 0.079 | 193.5 | 0.681 | 8.1 | 1.7 | 2.1 | 2.7 |
| Ex 10 | 1 | B | 2 | 0.079 | 193.6 | 0.680 | 8.2 | 1.7 | 1.9 | 2.8 |
| Ex 11 | 1 | C | 2 | 0.080 | 193.3 | 0.679 | 8.1 | 2.0 | 1.9 | 2.4 |
| Ex 12 | 3 | B | 2 | 0.079 | 192.9 | 0.677 | 8.1 | 1.8 | 2.0 | 2.7 |
| Comp Ex 5 | 1 | — | 2 | 0.078 | 192.5 | 0.665 | 8 | 2.8 | 0.0 | 0.0 |
| Ex 13 | 1 | A | 3 | 0.081 | 225.6 | 0.800 | 15.2 | 2.2 | 1.6 | 2.5 |
| Ex 14 | 3 | B | 3 | 0.082 | 225.1 | 0.795 | 15.3 | 2.3 | 1.5 | 2.6 |
| Comp Ex 6 | 1 | — | 3 | 0.079 | 214.5 | 0.775 | 15.1 | 3.1 | 0.0 | 0.0 |

It is apparent that the magnetic recording tape according to the present invention has a small surface roughness and achieves high output, high S/N, and high density recording.

### Examples 15 to 26 a Comparative Examples 7 to 10

A nonmagnetic coating composition selected from nonmagnetic coating compositions 5 to 8 was applied to a 50 μm thick polyethylene terephthalate substrate to a dry thickness of 1.8 μm and dried to form a nonmagnetic layer. A dispersion selected from dispersions A to F was applied to the nonmagnetic layer by coil bar coating while scraping off excessive dispersion with a doctor blade. The coating layer was dried and irradiated with an electron beam (acceleration voltage: 200 kV) at a dose of 50 kGy in a nitrogen atmosphere having an oxygen concentration of 200 ppm or less to cause the binder to cure. Magnetic coating composition 2 or 3 was applied thereon to a wet thickness of 250 nm using separate coating equipment, and the excess of the composition applied was scraped with a blade to give a dry coating thickness of 90 nm. While the magnetic layer was wet, it was oriented at random by passing through an alternating magnetic field generator (24 kA/m at a frequency of 50 Hz and 12 kA/m at a frequency of 50 Hz) As a result, an orientation ratio of 98% or higher was obtained.

The opposite side of the substrate was coated, oriented, and dried in the same manner as described above. The both-sided film was passed through a 7-roll calender at a roll temperature of 90° C. and a linear pressure of 300 kg/cm (294 kN/m) and punched to disks of 3.5 inch diameter. The disks were heat treated at 70° C. for 24 hours to accelerate curing of the coating. The coating surfaces were burnished with abrasive tape to scrape off the surface projections to obtain floppy disks. The magnetic characteristics, surface roughness, and electromagnetic characteristics of the resulting floppy disks were measured as followed. Separately, each of the nonmagnetic coating compositions 5 to 8 was applied on the substrate to a dry thickness of 1.8 μm to prepare samples having only the nonmagnetic layer, and the characteristics of the nonmagnetic layer were measured in the same manner as in Examples 1 to 14. The thickness of the magnetic layer was measured in the same manner as in Examples 1 to 14.

S/N measurement was carried out by using a disk testing system including a read-write analyzer RWA 1001 (from Guzik Technical Enterprises), a spinstand LS-90 (from Kyodo Denshi System Co., Ltd.), and a composite GMR head (write track width: 1.0 μm; read track width: 0.6 μm). Signals were recorded at a position of 24.4 mm radius, a speed of 5000 rpm, and a linear recording density of 300 kfci. The reproduction output and the DC-erased noise level were measured to obtain an SN ratio.

The magnetic characteristics were measured with a vibrating sample magnetometer in an applied magnetic field of 796 kA/m.

The results of measurements are shown in Table 4 below. The S/N of the samples using magnetic coating compositions 2 or 3 were relatively expressed taking, as standards, the results of Comparative Examples 9 and 10, respectively, in which the pores of the nonmagnetic layer surface were not filled. The results of the measurements of the nonmagnetic layer characteristics have been shown in Table 1.

TABLE 4

| | | | | | Magnetic | | | | |
|---|---|---|---|---|---|---|---|---|---|
| | Nonmagnetic | | Magnetic Layer | | Characteristics | | | | |
| Example | Coating | Filler | Coating | Thickness δ | Hc | | Br · δ | SRa | S/N |
| No. | Composition | Dispersion | Composition | (μm) | (kA/m) | SQ | (mT · μm) | (nm) | (dB) |
| Ex 15 | 5 | A | 2 | 0.089 | 178.5 | 0.584 | 7.9 | 1.6 | 2.5 |
| Ex 16 | 6 | A | 2 | 0.090 | 178.5 | 0.583 | 7.9 | 1.7 | 2.7 |
| Ex 17 | 6 | B | 2 | 0.089 | 178.4 | 0.585 | 7.8 | 1.7 | 2.7 |
| Ex 18 | 6 | C | 2 | 0.091 | 178.5 | 0.581 | 7.9 | 1.8 | 2.6 |
| Ex 19 | 6 | D | 2 | 0.090 | 178.4 | 0.582 | 7.8 | 2.0 | 2.4 |
| Ex 20 | 7 | A | 2 | 0.091 | 178.4 | 0.586 | 7.9 | 1.8 | 2.8 |
| Ex 21 | 8 | A | 2 | 0.090 | 178.4 | 0.584 | 7.8 | 1.7 | 2.7 |
| Comp Ex 7 | 6 | E | 2 | 0.092 | 178.3 | 0.575 | 7.8 | 2.6 | 0.8 |
| Comp Ex 8 | 6 | F | 2 | 0.091 | 178.2 | 0.566 | 7.7 | 2.9 | 0.2 |
| Comp Ex 9 | 6 | — | 2 | 0.089 | 178.3 | 0.570 | 7.7 | 2.6 | 0.0 |
| Ex 22 | 6 | A | 3 | 0.089 | 211.3 | 0.555 | 11.7 | 2.1 | 2.2 |
| Ex 23 | 6 | B | 3 | 0.090 | 211.4 | 0.556 | 11.8 | 2.0 | 2.3 |
| Ex 24 | 6 | C | 3 | 0.090 | 211.3 | 0.552 | 11.8 | 2.2 | 2.1 |
| Ex 25 | 6 | D | 3 | 0.089 | 211.1 | 0.550 | 11.7 | 2.3 | 2.2 |
| Ex 26 | 7 | C | 3 | 0.089 | 211.3 | 0.560 | 11.8 | 2.1 | 2.0 |
| Comp Ex 10 | 6 | — | 3 | 0.088 | 209.8 | 0.525 | 11.6 | 3.2 | 0.0 |

It is seen that the floppy disk according to the present invention has a small surface roughness and a high S/N. Accordingly, it is capable of high-density recording with a low error rate.

This application is based on Japanese Patent application JP 2006-91897, filed Mar. 29, 2006, the entire content of which is hereby incorporated by reference, the same as if set forth at length.

What is claimed is:

1. A magnetic recording medium comprising:
a substrate;
a nonmagnetic layer containing nonmagnetic powder and a binder; and
a magnetic layer containing ferromagnetic powder and a binder, in this order,
wherein the nonmagnetic layer has a thickness of from 0.5 to 2.5 μm, a specific surface area of from 20 to 120 m²/ml, a pore volume of from 0.15 to 0.40 ml/ml, and a median pore radius of from 3 to 16 nm, and the nonmagnetic layer has particles having an average particle diameter of from 4 to 14 nm on a magnetic layer side.

2. The magnetic recording medium according to claim 1, wherein the particles has an average particle diameter of from 5 to 14 nm.

3. The magnetic recording medium according to claim 1, wherein the particles has an average particle diameter of from 5 to 13 nm.

4. The magnetic recording medium according to claim 1, wherein the nonmagnetic layer has pores filled with the particles having an average particle diameter of from 4 to 14 nm.

5. The magnetic recording medium according to claim 1, wherein the magnetic layer has a thickness of from 25 to 150 nm.

6. The magnetic recording medium according to claim 1, wherein the magnetic layer has a thickness of from 25 to 100 nm.

7. The magnetic recording medium according to claim 1, wherein the magnetic layer has a thickness of from 25 to 90 nm.

8. The magnetic recording medium according to claim 1, wherein the average particle diameter of the particles is not larger than a desorption pore radius D90 of the nonmagnetic layer.

9. The magnetic recording medium according to claim 1, wherein the average particle diameter of the particles is not larger than the (desorption pore radius D10+desorption pore radius D90)/2 of the nonmagnetic layer.

10. The magnetic recording medium according to claim 1, which is for use in recording signals and reproducing the recorded signals using a giant magnetoresistive head having a read track width of 1 μm or smaller.

11. The magnetic recording medium according to claim 1, wherein the nonmagnetic layer has a thickness of from 0.5 to 2.0 μm.

12. The magnetic recording medium according to claim 1, wherein the nonmagnetic layer has a thickness of from 0.6 to 2.0 μm.

13. A process for producing a magnetic recording medium including a substrate, a nonmagnetic layer containing nonmagnetic powder and a binder, and a magnetic layer containing ferromagnetic powder and a binder in this order, the process comprising:
applying a coating composition containing a nonmagnetic powder and a binder on a substrate to form a nonmagnetic layer having a thickness of from 0.5 to 2.5 μm, a specific surface area of from 20 to 120 m²/ml, a pore volume of from 0.15 to 0.40 ml/ml, and a median pore radius of from 3 to 16 nm;
applying a dispersion containing particles having an average particle diameter of from 4 to 14 nm on the nonmagnetic layer; and
applying a coating composition containing ferromagnetic powder and a binder on the nonmagnetic layer onto which the dispersion is applied, to form a magnetic layer.

14. The process according to claim 13, wherein the dispersion contains 2% to 15% by weight of the particles which have an average diameter of not greater than the desorption pore radius D90 of the nonmagnetic layer.
